(19) United States
(12) Patent Application Publication
(10) Pub. No.: US 2002/0031102 A1
(43) Pub. Date: Mar. 14, 2002

(54) On-board DNS service for a satellite ISP system using non-geosynchronous orbit satellites

(75) Inventors: Robert A. Wiedeman, Sedalia, CO (US); Prashant V. Waknis, Mountain View, CA (US)

Correspondence Address: Harry F. Smith, Esq., Ohlandt, Greeley, Ruggiero & Perle, L.L.P., 10th Floor, One Landmark Square, Stamford, CT, 06901-2682, US

(73) Assignee: GLOBALSTAR L.P., SAN JOSE, CA (US)

(21) Appl. No.: 09/841,357

(22) Filed: Apr. 24, 2001

Related U.S. Application Data
(60) Provisional application No. 60/201,110, filed on May 2, 2000.

(51) Int. Cl. H04B 7/185; H04L 12/66; H04B 7/212

(52) U.S. Cl. 370/316; 370/349; 370/352

(57) ABSTRACT

A method includes transmitting a Domain Name Service (DNS) query from a user terminal; receiving the DNS query with at least one satellite in earth orbit; and applying the DNS query to a DNS server that is on-board the at least one satellite to obtain a corresponding Internet Protocol (IP) address. The method further operates, in the event the DNS server is unable to obtain the corresponding IP address, to transmit the DNS query to another DNS server, which may be located in another satellite, such as a higher altitude satellite, or to a terrestrial DNS server, such as one at a gateway or one reachable through the Internet. The method further operates to update the DNS server database that is on-board the satellite with information received from a terrestrial DNS server and/or from a space-based DNS server. In a further method the user terminal transmits a message containing a Uniform Resource Locator (URL); the message is received with at least one satellite in earth orbit; and a processor of the satellite generates, in response to the URL, a DNS query to a DNS server that is on-board the at least one satellite to obtain a corresponding Internet Protocol (IP) address. In the event the DNS server is unable to obtain the corresponding IP address, the processor transmits the DNS query to another DNS server located on-board another satellite, or to a terrestrially-located DNS server. A further operation performed by the method forwards the message to an Internet destination server having an address that corresponds to the IP address.

### CLAIM OF PRIORITY FROM COPENDING PROVISIONAL PATENT APPLICATION

This application claims priority under 35 U.S.C. 119(e) and 120 from provisional patent application No. 60/201,110, filed on May 2, 2000, the disclosure of which is incorporated by reference herein in its entirety.

### FIELD OF THE INVENTION

These teachings relate generally to satellite-based communication systems and, more particularly, relate to non-geosynchronous orbit satellite communication systems, such as Low Earth Orbit (LEO) and Medium Earth Orbit (MEO) satellite communication systems, as well as to Domain Name Service (DNS) servers.

### BACKGROUND OF THE INVENTION

In U.S. patent application Ser. No. 09/334,386, filed Jun. 16, 1999, entitled “ISP System Using Non-Geosynchronous Orbiting Satellites,” by Robert A. Wiedeman, there are disclosed embodiments of satellite-based communication systems that extend the Internet using non-geosynchronous orbit satellites. A user in a remote location can use the LEO constellation to access the Internet. The satellites in this system become part of the Internet and act as access points for User Terminals (UTs) in remote areas. This U.S. patent application is incorporated by reference in its entirety, insofar as it does not conflict with these teachings. One of the most frequent operations performed by Internet users is a Domain Name Service (DNS) Query. Typically, the user knows the Uniform Resource Locator (URL) of the site the user wishes to access (such as www.company_name.com). When the user types the URL in a browsing application (such as Netscape™), the browsing application makes a query to a DNS server to determine the corresponding Internet Protocol (IP) address. Once the browsing application has the destination IP address, it can then use this address to send IP packets (typically containing data or a request for data) towards the destination. Thus, the Domain Name Service is one of the most often used services when accessing the Internet.

The DNS database is typically stored in hierarchical fashion. The browser in the above example accesses a DNS server. If this DNS server does not have the required IP address, the DNS server searches for the address at another DNS server at a higher level in the DNS hierarchy.

When a user employs a satellite to access the Internet, via a User Terminal (UT), the user may be in a remote area and/or the user may be mobile. When the user desires to access the Internet, and the IP address of the Internet host (destination host) is not known to the UT, the UT must make a DNS query. The DNS query is transmitted to the satellite, and the satellite then sends the DNS query directly to a terrestrial satellite gateway, or the query could be relayed to the gateway through one or more other satellites using Inter-Satellite Links (ISLs). The gateway is connected to at least one terrestrial communication system, such as the Public Switched Telephone Network (PSTN) and/or to a packet data communication network. In any case, the gateway is assumed to be capable of connecting to the Internet or to some other network of interest and, thence, to a DNS or equivalent type of server. The DNS response from the server travels back through the gateway and one or more satellites of the satellite constellation to the UT. The UT, now having the IP address of the destination host, can begin to communicate with the destination host.

As may be appreciated, the operation described above can be time consuming and inefficient. For example, to send a small electronic mail message, the DNS query for the destination IP address may require more time to complete than is required to send the electronic mail message itself. This conventional DNS process is clearly inefficient, especially for small messages, and is thus inefficient overall, as most of the messages generated by web browsers are small messages. Typically, these messages contain only a URL, and the total message size is often less than 100 bytes.

### SUMMARY OF THE INVENTION

The foregoing and other problems are overcome by methods and apparatus in accordance with embodiments of these teachings. These teachings provide methods that use satellite on-board processing capacity and satellite on-board memory for performing DNS resolutions.

A method is disclosed for operating a satellite telecommunications system, as is a system that operates in accordance with the method. The method includes transmitting a Domain Name Service (DNS) query from a user terminal; receiving the DNS query with at least one satellite in earth orbit; and applying the DNS query to a DNS server that is on-board the at least one satellite to obtain a corresponding Internet Protocol (IP) address. The method further operates, in the event the DNS server is unable to obtain the corresponding IP address, to transmit the DNS query to another DNS server, which may be located in another satellite, such as a higher altitude satellite, or to a terrestrial DNS server, such as one at a gateway or one reachable through the Internet. The method further operates to update the DNS server database that is on-board the satellite with information received from a terrestrial DNS server and/or from a space-based DNS server.

In a further method the user terminal transmits a message containing a Uniform Resource Locator (URL); the message is received with at least one satellite in earth orbit; and a processor of the satellite generates, in response to the URL, a DNS query to a DNS server that is on-board the at least one satellite to obtain a corresponding Internet Protocol (IP) address. In the event the DNS server is unable to obtain the corresponding IP address, the processor transmits the DNS query to another DNS server located on-board another satellite, or to a terrestrially-located DNS server. A further operation performed by the method forwards the message to an Internet destination server having an address that corresponds to the IP address.

### BRIEF DESCRIPTION OF TILE DRAWINGS

The above set forth and other features of these teachings are made more apparent in the ensuing Detailed Description of the Preferred Embodiments when read in conjunction with the attached Drawings, wherein:

FIG. 1 is a simplified block diagram of a mobile satellite telecommunications system (MSTS) that is suitable for practicing these teachings;

FIG. 2 is a block diagram showing a DNS server that is located on the non-geosynchronous orbit satellite depicted in FIG. 1;

FIG. 3 shows the satellite-resident DNS server of FIG. 2 coupled to a DNS server located on a geosynchronous satellite;

FIG. 4 is a logic flow diagram depicting a first method in accordance with these teachings; and

FIG. 5 is a logic flow diagram depicting a second method in accordance with these teachings.

### DETAILED DESCRIPTION OF THE PREFERRED EMBODIMENTS

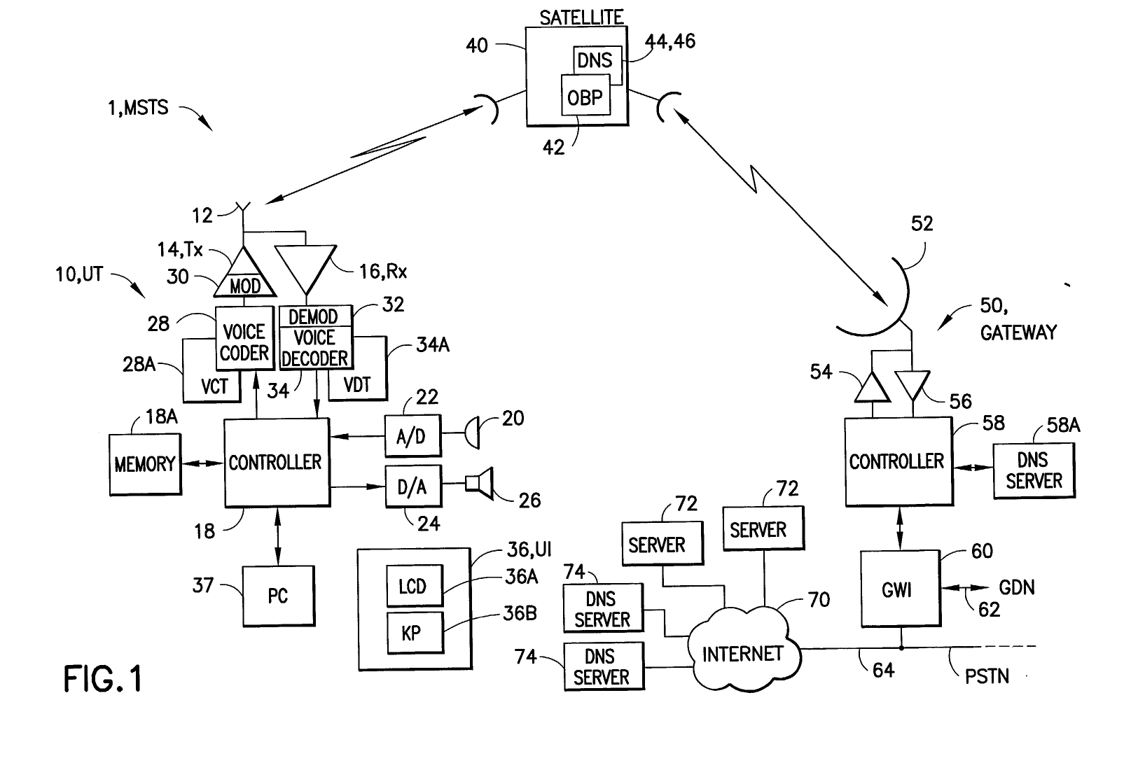

Reference is made to FIG. 1 for illustrating a simplified block diagram of a digital wireless telecommunications system, embodied herein as a mobile satellite telecommunications system (MSTS) 1, that is suitable for practicing these teachings. While described in the context of the MSTS 1, those skilled in the art should appreciate that certain of these teachings may have application to terrestrial telecommunications systems as well.

The MSTS 1 includes at least one, but typically many, wireless user terminals (UTs) 10, at least one, but typically several, communications satellite 40, and at least one, but typically several, communications ground stations or gateways 50.

Reference in this regard can be had, by example, to U.S. Pat. No.: 5,526,404, “Worldwide Satellite Telephone System and a Network Coordinating Gateway for Allocating Satellite and Terrestrial Resources”, by Robert A. Wiedeman and Paul A. Monte; to U.S. Pat. No.: 5,303,286, “Wireless Telephone/Satellite Roaming System”, by Robert A. Wiedeman; to U.S. Pat. No.: 5,619,525, “Closed Loop Power Control for Low Earth Orbit Satellite Communications System, by Robert A. Wiedeman and Michael J. Sites; and to U.S. Pat. No.: 5,896,558 “Interactive Fixed and Mobile Satellite Network”, by Robert A. Wiedeman, for teaching various embodiments of satellite communications systems, such as low earth orbit (LEO) satellite systems, that can benefit from these teachings. The disclosures of these various U.S. Patents are incorporated by reference herein in their entireties, in so far as they do not conflict with the teachings of this invention.

The exemplary UT 10 includes at least one antenna 12 for transmitting and receiving RF signals and an RF transmitter (TX) 14 and an RF receiver (RX) 16 having an output and an input, respectively, coupled to the antenna 12. A controller 18, which may include one or more microprocessors and associated memories 18a and support circuits, functions to control the overall operation of the UT 10. An input speech transducer, typically a microphone 20, provides a user's speech signals to the controller 18 through a suitable analog to digital (A/D) converter 22. An output speech transducer, typically including a loudspeaker 26, outputs received speech signals from the controller 18, via a suitable digital to analog (D/A) converter 24. The UT 10 will also typically comprise some type of user interface (UI) 36 that is coupled to the controller 18, such as a LCD display 36A and a keypad 36B. The UT 10 may also be coupled with a computing device, such as a laptop computer or a PC 37, and may thus function as a wireless modem for the PC 37.

A transmit path may include a desired type of voice coder (vocoder) 28 that receives a digital representation of the input speech signals from the controller 18, and includes voice coder tables (VCT) 28a and other required support circuitry, as is well known in the art. The output of the vocoder 28, which is a lower bit rate representation of the input digital speech signals or samples, is provided to a RF modulator (MOD) 30 for modulating a RF carrier, and the modulated RF carrier is upconverted to the transmission frequency and applied to the input to the RF transmitter amplifier 14. Signaling information to be transmitted from the UT 10 is output from the controller 18 to a signaling path that bypasses the vocoder 28 for application directly to the modulator 30. Not shown or further discussed is the framing of the transmitted signal for a TDMA type system, or the spreading of the transmitted signal for a CDMA type system, since these operations are not germane to an understanding of this invention. Other operations can also be performed on the transmitted signal, such as Doppler precorrection, interleaving and other well known operations.

A receive path may include the corresponding type of voice decoder 34 that receives a digital representation of a received speech signal from a corresponding type of demodulator (DEMOD) 32. The voice decoder 34 includes voice decoder tables (VDT) 34a and other required support circuitry, also as is well known in the art. The output of the voice decoder 34 is provided to the controller 18 for audio processing, and is thence sent to the D/A converter 24 and the loudspeaker 26 for producing an audible voice signal for the user. As with the transmitter path, other operations can be performed on the received signal, such as Doppler correction, de-interleaving, and other well known operations. In a manner analogous to the transmit path, received signaling information is input to the controller 18 from a signaling path that bypasses the voice decoder 34 from the demodulator 32.

It is pointed out that the above-mentioned speech capability is not required to practice these teachings, as the UT 10 may operate solely as a data communications device. In this mode of operation the vocoder(s) may simply be bypassed, and the data signals modulated/demodulated, interleaved/de-interleaved, etc. In a data-only application the UT 10 may be constructed so as not to include any analog voice capability at all. Furthermore, in a data-only application the user interface 36 may not be required, particularly if the UT 10 is wholly or partially embedded within another device, such as the PC 37.

The RF signals transmitted from the UT 10 and those received by the UT 10 pass through at least one satellite 40, which may be in any suitable altitude and orbital configuration (e.g., circular, elliptical, equatorial, polar, etc.) In the preferred embodiment the satellite 40 is one of a constellation of non-geosynchronous orbit (non-GEO) satellites, preferably Low Earth Orbit (LEO) satellites, although one or more Medium Earth Orbit (MEO) satellites could be used as well, as could one or more geosynchronous orbit satellites in conjunction with LEO or MEO satellites, as described below. In the preferred embodiment the satellite 40 provides an on-board processor (OBP) 42, wherein a received transmission is at least partially demodulated to baseband, processed on the satellite 40, re-modulated and then transmitted. As will be discussed below, in accordance with these teachings the on-board processing conducted by the satellite 40 includes DNS query resolution.

The satellite 40 serves to bidirectionally couple the UT 10 to the gateway 50. The gateway 50 includes a suitable RF antenna 52, such as steerable parabolic antenna, for transmitting and receiving a feederlink with the satellite 40. The feederlink will typically include communication signals for a number of UTs 10. The gateway 50 further includes a transceiver, comprised of transmitters 54 and receivers 56, and a gateway controller 58 that is bidirectionally coupled to a gateway interface (GWI) 60. The GWI 60 provides connections to a Ground Data Network (GDN) 62 through which the gateway 50 communicates with a ground operations control center (not shown) and possibly other gateways. The GWI 60 also provides connections to one or more terrestrial telephone and data communications networks 64, such as the PSTN, whereby the UT 10 can be connected to any wired or wireless telephone, or to another UT, through the terrestrial telecommunications network. In accordance with an aspect of these teachings the gateway 50 provides an ability to reach the Internet 70, which provides access to various servers 72 as well as DNS servers 74. The gateway 50 also includes banks of modulators, demodulators, voice coders and decoders, as well as other well known types of equipment, which are not shown to simplify the drawing.

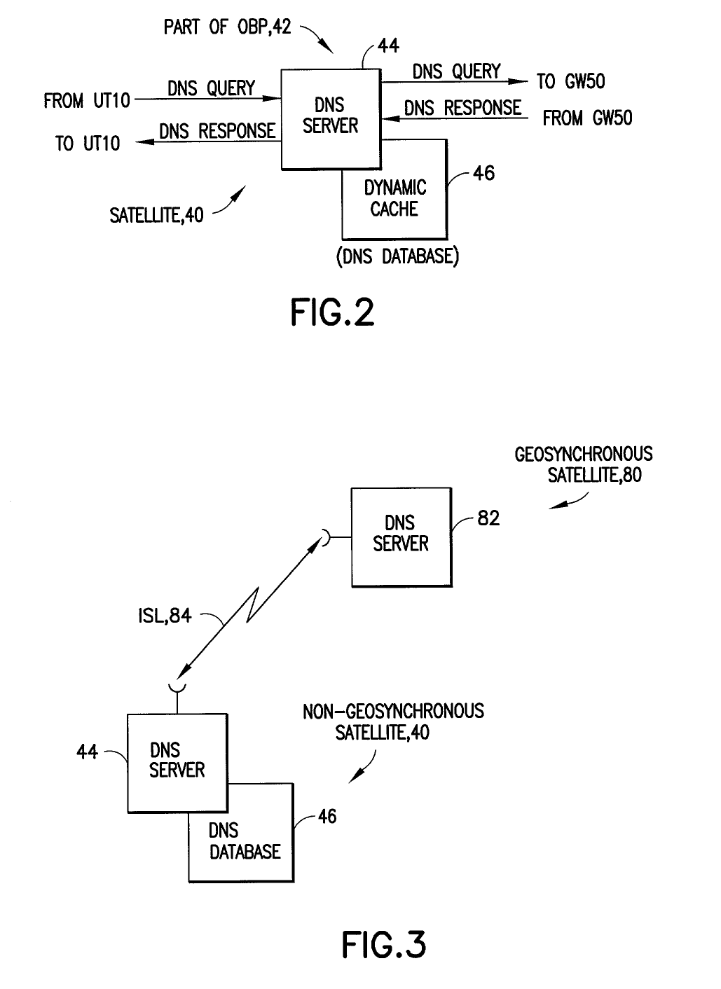

Having thus described one suitable but not limiting embodiment of a mobile satellite telecommunications system that can be used to practice these teachings, reference is now made to FIG. 2 for illustrating the construction of the satellites 40.

The satellite on-board processor 42 participates in the DNS activity, and DNS server software is thus incorporated on the satellite 40. The DNS server 44 on the satellite 40 may be considered as a leaf node in the DNS hierarchy, and operates to respond to many of the DNS queries from the UT 10 users. If the DNS server 44 does not have the IP address of a requested URL, then it obtains the address from another DNS server in the DNS hierarchy. The next node in the DNS hierarchy may be the gateway 40, if the gateway 40 also includes a DNS server 58A. If the optional DNS server 58A of the gateway 40 does not have the required IP address, or if the gateway 40 does not incorporate the DNS server, the gateway 40 forwards the DNS query to the next node in the DNS hierarchy, typically a DNS server node 74 in the Internet 70.

As is shown in FIG. 2, the satellite DNS server 44 may include a dynamic cache 46 and associated caching algorithm for implementing the DNS database of IP addresses. The DNS algorithm may store the IP addresses for more frequently requested URLs in order to maximize the number of hits in the cache 46. That is, the DNS caching algorithm operates to maximize the number of times the users' DNS queries are resolved at the satellite 40.

The UT 10 may include a web browser, or an attached device, such as the PC 37, may include the web browser. For web browsing, instead of first making a DNS request for the IP address of a destination server, and then sending the IP address of the corresponding server with the message, the UT 10 may directly send to the satellite 40 the URL and the request to connect to the corresponding server 72. For example, the UT 10 may transmit “www.company_name.com” to the satellite 40, along with a message requesting connection to the corresponding server 72. The satellite DNS server 44 then acts on this information. The DNS query for www.company_name.com is resolved at the satellite 40, or in another DNS server 58A or 74 in the DNS hierarchy. The satellite on-board processor 42 then sends the message to establish the connection to the destination server 72 on the behalf of the user of the UT 10. This mode of operation eliminates the time that the UT 10 spends in communication for making the DNS queries, and works equally well if the UT 10 has a small message (for example, an e-mail) to send. As was stated earlier, since most messages that a UT 10 initiates are small messages (e.g., about 100 bytes or less), this method proves to be more efficient than having to make a DNS query first.

Referring now to FIG. 3, the use of an on-board processor and on-board memory of a geosynchronous orbit (GEO) satellite 80 may also be used to realize another DNS server 82, which forms another DNS node in the DNS hierarchy. In this case the non-geosynchronous orbit satellite 40 communicates through an Inter-Satellite Link (ISL) 84 with the GEO satellite 80 to forward a DNS query, and to receive the DNS response if available. In this embodiment, if the DNS server 44 residing on the non-GEO satellite 40 cannot resolve the DNS query, the non-GEO DNS server 44 forwards the DNS query to the GEO-resident DNS server 82. In this manner the DNS query may be resolved entirely in the space segment of the MSTS 1. If the GEO-resident DNS server 82 is unable to resolve the DNS query, then the DNS query may be forwarded by the GEO satellite 80 to the same or a different gateway 50 for resolution by one of the DNS server nodes 74, or the DNS query may be forwarded by the non-GEO satellite 40 to the gateway 50 for resolution by the gateway DNS server 58A (if available), or by one of the DNS server nodes 74.

The GEO satellite 80 may be used to periodically update the DNS database 46 of the non-GEO satellite 40. The GEO satellite 80 may execute the caching algorithm, and may store the most frequently accessed URLs from UTs 10 located in its coverage area or footprint. The GEO satellite 80 may update the DNS entries in the database 46 on non-GEO satellite(s) 40 using either a broadcast or a unicast transmission. As an example of unicast operation, the non-GEO satellite 40 may communicate with the GEO satellite 80 to update the DNS database 46 every time the non-GEO satellite 40 appears within the footprint of the GEO satellite 80. As an example of broadcast operation, the GEO satellite 80 may broadcast the current DNS database 82 after a certain time interval to all the non-GEO satellites 40 located in its footprint. In this manner the GEO satellite 80 is responsible for maintaining the DNS database for its foot-print, and for transferring the DNS database to the non-GEO satellites 40 that are currently located within its footprint.

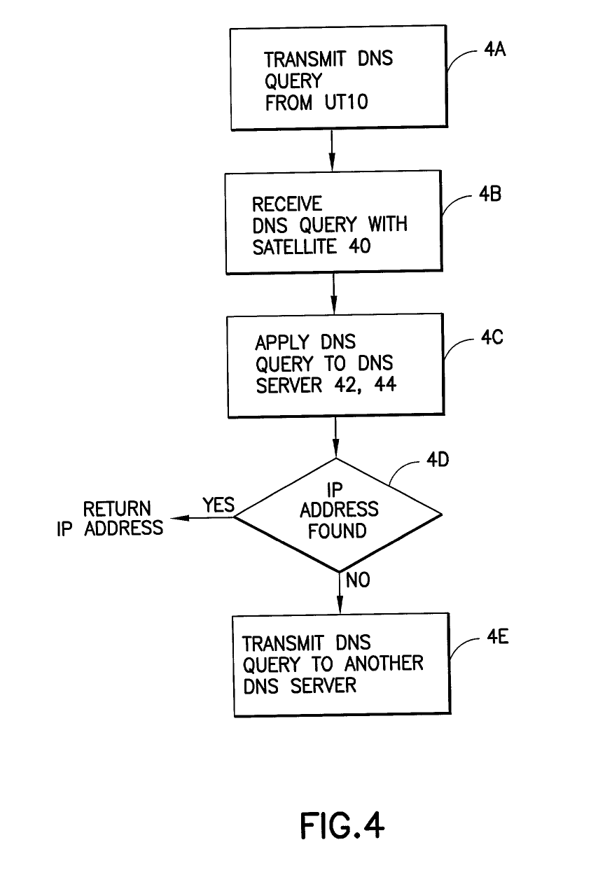

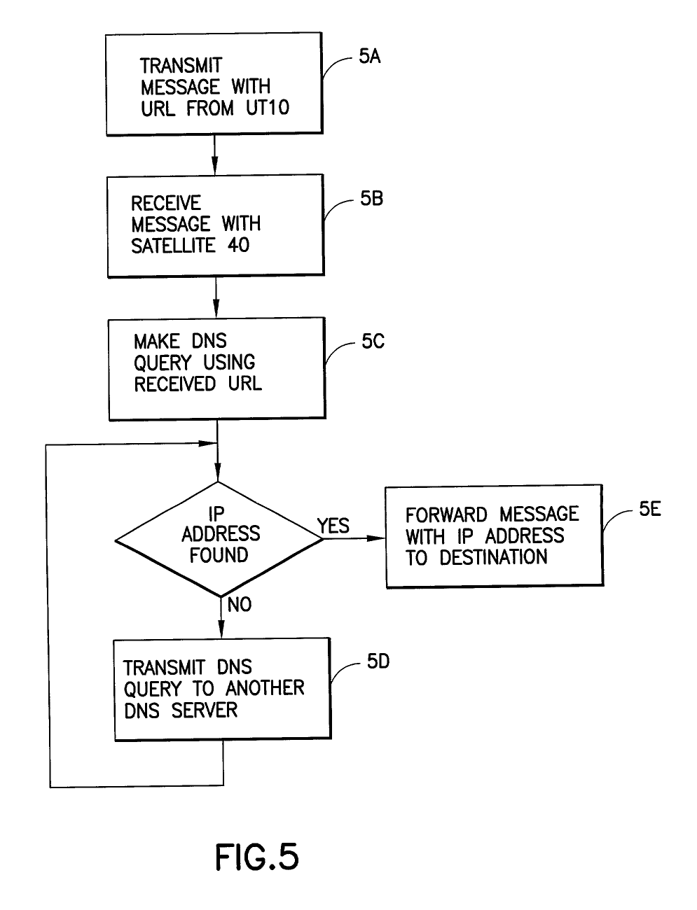

Referring to FIG. 4, a method includes transmitting a Domain Name Service (DNS) query from a user terminal 10 (Block 4A); receiving the DNS query with at least one satellite 40 in earth orbit (Block 4B); and applying the DNS query to a DNS server 44 that is on-board the at least one satellite to obtain a corresponding Internet Protocol (IP) address (Block 4C). The method further operates, in the event the DNS server is unable to obtain the corresponding IP address (Block 4D), to transmit the DNS query to another DNS server (Block 4E), which may be located in another satellite, such as a higher altitude satellite (e.g., at the GEO satellite 80), or to a terrestrial DNS server, such as the DNS server 58A at the gateway 50 or a DNS server 74 reachable through the Internet 70. The method further operates to update the DNS server database that is onboard the satellite with information received from a terrestrial DNS server and/or from a space-based DNS server.

Referring to FIG. 5, in a further method the user terminal 10 transmits a message containing a Uniform Resource Locator (URL) at Block 5A; the message is received with the at least one satellite 40 in earth orbit at Block 5B; and a processor (OBP 42) of the satellite 40 generates, in response to the URL, a DNS query to the DNS server 44 that is on-board the at least one satellite to obtain a corresponding Internet Protocol (IP) address (Block 5C). In the event the DNS server 44 is unable to obtain the corresponding IP address, the processor 42 transmits the DNS query to another DNS server 82 located on-board another satellite 80, or to a terrestrially-located DNS server 58A, 74, at Block 5D. A further operation forwards the message to an Internet destination server 72 having an address that corresponds to the IP address (Block 5E).

These teachings thus provide a non-GEO satellite constellation (e.g., a LEO satellite constellation) that extends the Internet in such a manner that the non-GEO satellites 40 participate in providing the DNS function.

The on-board DNS server 44 uses the dynamic database 46 that maps URLs to IP addresses, and may employ an associated efficient caching algorithm to update the DNS database 46 on a regular basis. The DNS database 46 can be updated using information received from or through the gateway 50, either alone or in combination with information received from the GEO satellite 80. Alternatively, the DNS database 46 may be updated using only information received from the GEO satellite 80.

These teachings also provide a mode of operation in which the UT 10 directly sends a message containing a URL to the satellite 40, where the satellite 40 may perform the DNS search to locate the corresponding IP address and to then send the message directly to the destination server 72, without the UT 10 being required to participate in or wait for a DNS query.

These teachings also provide a DNS operation that is realized at least in part by a cooperation between non-GEO and GEO satellites 40 and 80, respectively.

It is pointed out that the second satellite 80 need not be in a geosynchronous orbit, but may be a satellite that is simply in a higher orbit than the satellite 40. For example, the satellite 40 may be a LEO satellite, and the satellite 80 may be a MEO satellite.

Thus, while these teachings have been particularly shown and described with respect to preferred embodiments thereof, it will be understood by those skilled in the art that changes in form and details may be made therein without departing from the scope and spirit of these teachings.

What is claimed is:

1. A mobile satellite telecommunications system, comprising:
at least one user terminal;
at least one satellite in earth orbit; and
at least one gateway bidirectionally coupled to a data communications network;
said at least one satellite comprising a Domain Name Service (DNS) server for responding to a DNS query that is received from said at least one user terminal.

2. A mobile satellite telecommunications system as in claim 1, wherein said DNS server is comprised of a DNS database that receives Internet Protocol address information from said gateway.

3. A mobile satellite telecommunications system as in claim 1, wherein said DNS server is comprised of a DNS database that receives Internet Protocol address information through said gateway.

4. A mobile satellite telecommunications system as in claim 1, wherein said at least one satellite is in a non-geosynchronous orbit, and further comprising at least one satellite in a higher orbit, wherein DNS server is comprised of a DNS database that receives Internet Protocol address information from said satellite in a higher orbit.

5. A mobile satellite telecommunications system as in claim 1, wherein said at least one satellite is in a non-geosynchronous orbit, and further comprising at least one satellite in a higher orbit that comprises a second DNS server, wherein said non-geosynchronous orbit satellite transmits a DNS query received from said user terminal to said satellite in said higher orbit.

6. A mobile satellite telecommunications system, comprising:
at least one user terminal;
at least one first satellite in a non-geosynchronous orbit, said first satellite comprising a first Domain Name Service (DNS) server for responding to a DNS query that is received from said at least one user terminal;
at least one second satellite in a geosynchronous orbit, said second satellite comprising a second Domain Name Service (DNS) server for responding to a DNS query that is received from said at least one first satellite; and
at least one gateway bidirectionally coupled to a data communications network.

7. A mobile satellite telecommunications system as in claim 6, wherein said first DNS server is comprised of a DNS database that receives Internet Protocol address information from said gateway.

8. A mobile satellite telecommunications system as in claim 6, wherein said first DNS server is comprised of a DNS database that receives Internet Protocol address information through said gateway.

9. A mobile satellite telecommunications system as in claim 6, wherein said first DNS server is comprised of a DNS database that receives Internet Protocol address information from said second satellite.

10. A mobile satellite telecommunications system as in claim 6, wherein said non-geosynchronous orbit satellite transmits a DNS query received from said user terminal to said second satellite.

11. A mobile satellite telecommunications system, comprising:
at least one user terminal;
at least one satellite in earth orbit; and
at least one gateway bidirectionally coupled to a data communications network;
said at least one satellite comprising a Domain Name Service (DNS) server and a processor that is responsive to a message that is received from said at least one user terminal, the received message containing a Uniform Resource Locator (URL) to which said processor responds by generating a DNS query to said DNS server to obtain a corresponding Internet Protocol (IP) address.

12. A method of operating a satellite telecommunications system, comprising:
transmitting a Domain Name Service (DNS) query from a user terminal;
receiving the DNS query with at least one satellite in earth orbit; and
applying said DNS query to a DNS server that is on-board said at least one satellite to obtain a corresponding Internet Protocol (IP) address.

13. A method as in claim 12, further comprising, in the event the DNS server is unable to obtain the corresponding IP address, transmitting the DNS query to another satellite.

14. A method as in claim 12, further comprising, in the event the DNS server is unable to obtain the corresponding IP address, transmitting the DNS query to a second satellite in a higher orbit, the second satellite also comprising a DNS server.

15. A method as in claim 12, further comprising, in the event the DNS server is unable to obtain the corresponding IP address, transmitting the DNS query to a gateway that also comprises a DNS server.

16. A method as in claim 12, further comprising, in the event the DNS server is unable to obtain the corresponding IP address, transmitting the DNS query to a gateway that is coupled to at least one further DNS server.

17. A method as in claim 12, further comprising updating a DNS server database with information received from a terrestrial DNS server.

18. A method as in claim 12, further comprising updating a DNS server database with information received from a space-based DNS server.

19. A method of operating satellite telecommunications system, comprising:
transmitting a message containing a Uniform Resource Locator (URL) from a user terminal;
receiving the URL with at least one satellite in earth orbit; and
generating, in response to said URL, a DNS query to a DNS server that is onboard said at least one satellite to obtain a corresponding Internet Protocol (IP) address.

20. A method as in claim 19, further comprising, in the event the DNS server is unable to obtain the corresponding IP address, transmitting the DNS query to another DNS server located on-board another satellite.

21. A method as in claim 19, further comprising, in the event the DNS server is unable to obtain the corresponding IP address, transmitting the DNS query to a terrestrially-located DNS server.

22. A method as in claim 19, further comprising, in the event the IP address is obtained, forwarding the message to an Internet destination server having an address that corresponds to the IP address.
